(19) United States
(12) Patent Application Publication
(10) Pub. No.: US 2003/0087002 A1
(43) Pub. Date: May 8, 2003

(54) Method for preparing a self-sufficient fermentation medium

(76) Inventors: Catherine Fouache, Sailly Labourse (FR); Laurent Segueilha, Lambersart (FR)

Correspondence Address: HENDERSON & STURM LLP, 1213 MIDLAND BUILDING, 206 SIXTH AVENUE, DES MOINES, IA, 50309-4076, US

(21) Appl. No.: 10/281,685

(22) Filed: Oct. 28, 2002

(30) Foreign Application Priority Data
Oct. 30, 2001 (FR) FR 01 14090

(51) Int. Cl. A23K 1/00

(52) U.S. Cl. 426/52

(57) ABSTRACT

The invention relates to a method for preparing a self-sufficient fermentation medium allowing the production of metabolites from a renewable raw material, characterized in that it consists in choosing the renewable raw material from the group consisting of wheat, pea and potato solubles, preferably wheat solubles, treating the said renewable raw material so as to release therefrom the carbon and nitrogen sources directly assimilable by microorganisms, and recovering the self-sufficient fermentation medium thus obtained.

The present invention relates to a particular method for preparing a self-sufficient fermentation medium from a renewable raw material.

More precisely, the present invention relates to a particular method for treating a renewable raw material, such that it is possible to use it directly in fermentation for the production of metabolites.

In the present invention, the expression “renewable raw material” is understood to mean food industry waste which is inexpensive, unrefined, generally nontoxic and rich in nitrogen and carbon sources. More particularly, this will involve coproducts of starch industries and still more particularly wheat, pea or potato starch industries.

The expression “self-sufficient fermentation medium” is also understood to mean a fermentation medium containing all the nutrients necessary for the growth of microorganisms and necessary and sufficient for the production of metabolites of interest, without the need to add any nutritive supplement thereto.

For the purposes of the invention, the expression “metabolites” is understood to mean the products of conversion, by the fermentative route, of carbon sources which are directly assimilable by microorganisms. They will be advantageously metabolites chosen from the group consisting of organic acids and amino acids, and preferably organic acids such as L-lactic acid, gluconic acid, citric acid, and amino acids such as L-Lysine or L-Threonine.

In general, it is accepted that the choice of a renewable raw material as a base intended for fermentation for the production of metabolites of interest is determined both by its availability, its cost and its capacity to allow high productivities.

However, it is also considered that a fermentation medium should not only consist of a carbon source, but also of a nitrogen source, to which minerals and organic salts are added.

It is accepted by specialists in the fermentation field that the “carbon source” may be obtained from renewable raw materials such as molasses, wheat, maize, rice, cassava or potato starch hydrolyzates, but the “directly assimilable carbon sources” are sugars, which are refined or purified from the said carbon sources, such as glucose, fructose, maltose, sucrose, lactose and dextrins.

Examples of “nitrogen sources” or protein nutrients are, for their part, yeast extracts, corn steep liquor, nondenatured milk, the proteins of molasses, meat extracts or soya bean meal. However, the use of yeast extracts as nitrogen sources and also as supplements for vitamins and for mineral elements is often preferred.

In most cases, the fermentation medium consisting of a “directly assimilable carbon source”, i.e. glucose or sucrose, and of yeast extracts, may be basically used for a good number of fermentations, such as fermentations leading to the production of organic acids, such as lactic, propionic, gluconic and citric acids, and the like, essential amino acids such as lysine or any other metabolite of industrial interest.

In patent application WO 98/54,351, it is thus, for example, described that for the preparation of the medium for producing L-Lysine, a carbon source may be chosen which is selected from the group consisting of sucrose, but also molasses, starch and starch hydrolyzates derived from various sources, such as maize and wheat.

It is however obligatory to add thereto a nitrogen source chosen from the group consisting of yeast extracts or molasses, proteins, peptides and amino acids, corn steep or solubles of wheat.

In the field of organic acids, there is for example chosen, for the production of lactic acid:

in U.S. Pat. No. 5,416,020, a method for producing L-Lactic acid from whey permeate and from whey, to which yeast extract is also added in the presence of divalent manganese, with a mutant of Lactobacillus delbrueckii sub. bulgaricus ATCC 55163 which produces essentially L-Lactic acid.

The whey permeate indeed contains from 75 to 80% by weight of lactose, but no longer contains large-sized proteins. It is therefore deficient in nitrogen source which is essential for the growth of microorganisms, hence the supplement made necessary as yeast extracts. The whey added contains essentially of the order of 65 to 75% by weight of lactose.

The yeast extract then provides the fermentation medium with the nutrients which are not sufficiently supplied by the whey permeates and the whey itself.

In U.S. Pat. No. 4,467,034, it is shown that it is possible to produce lactic acid from whey as raw material, using a novel Lactobacillus bulgaricus DSM 2129. The whey must nevertheless still be supplemented with a nitrogen source, i.e. meat extract, corn steep or soya bean meal, and also with vitamins and mineral salts.

Under these conditions, the use of these fermentation media requires complex combinations complying with the nitrogen/carbon ratio, plus the addition of supplements necessary for an efficient productivity of the microorganisms of interest.

These media are also used for the production of biomass (for example for the preparation of lactic ferments), but also exhibit the same order of difficulties, due to the metabolic requirements of the microorganisms considered.

Moreover, it is accepted that these media have, furthermore, the disadvantage. of not being extrapolatable to the production, on an industrial scale, of these same metabolites of interest (difficulty of having standard media in terms of their composition and additional costs caused by the subsequent purification steps).

The result of the preceding text is that a nonsatisfied need exists to have a simple and effective method which makes it possible to prepare a fermentation medium without using cumbersome, numerous and expensive steps, both at the level of the choice of carbon and nitrogen sources of the fermentation medium and their combination in order to manufacture a balanced fermentation medium suitable for the fermentation considered.

Anxious to develop a method which makes it possible to respond, better than those which already exist, to the constraints of practical use, the applicant company has observed that this objective could be achieved by a method consisting in preparing a self-sufficient fermentation medium directly from a renewable raw material.

More particularly, the method for preparing a fermentation medium allowing the production of metabolites from a renewable raw material in accordance with the invention of the applicant company is characterized in that it consists in:

choosing the renewable raw material from the group consisting of wheat, pea and potato solubles, preferably wheat solubles,

treating the said renewable raw material so as to release therefrom the carbon and nitrogen sources directly assimilable by microorganisms,

recovering the self-sufficient fermentation medium thus obtained.

The first step of the method in accordance with the invention therefore consists in choosing the renewable raw material from the group consisting of wheat, pea and potato solubles, preferably wheat solubles.

The applicant company has thus overcome the technical bias according to which the preparation of a fermentation medium should necessarily mean the reconstitution of a composite fermentation medium, mainly from a carbon source and a nitrogen source of separate origins, with the addition of vitamins, growth factor and trace elements.

As has been said above, it is indeed conventionally considered in the state of the art that a composite fermentation medium should be available in order to obtain the production of a metabolite of interest with good yield and productivity.

However, this need is accompanied in particular by a major disadvantage, which consists in its high cost, and by a difficulty, which is to adjust it to the requirements of the producing microorganisms.

After numerous long and tedious research studies, the applicant company has the merit to have found in renewable raw materials, and more particularly in the residues of wheat, pea and potato starch industries, the fermentation medium adapted to the requirements of practical use.

More particularly, and here again in going against another technical bias, the applicant company has found that this renewable raw material should be advantageously chosen from the group consisting of wheat, pea and potato solubles, whereas it is commonly accepted that these solubles only constitute as such a nitrogen source for the constitution of fermentation media.

It has thus been found that these solubles could be directly used, after the treatment in accordance with the invention by the applicant company, not only as a nitrogen source, but also as a unique source of carbon and of trace elements, or even of vitamins, which is necessary and sufficient for fermentation by any microorganism of interest.

The wheat solubles, for example, are obtained from the separation stream of wheat “B” starches resulting from the separation of starch in the wet wheat starch milling process.

B starch or second starch is starch consisting essentially of a preponderant proportion of small starch granules or of damaged granules.

Besides this B starch, it is known that wheat solubles also contain non-negligible quantities of high-molecular-weight proteins capable of constituting a nitrogen source for microorganisms of interest.

As for potato solubles, they are obtained by recovering the soluble fraction derived from crushing potatoes at the start of extraction of starch.

Pea solubles result from pea steep water and are recovered before crushing and separation of the various constituents of the pea.

The second step of the method in accordance with the invention therefore consists in treating the said renewable raw material so as to release therefrom the carbon and nitrogen sources directly assimilable by microorganisms.

The renewable raw materials here contain both starch, as source of carbon or glucose, and high-molecular-weight proteins, besides peptides and free amino acids as nitrogen source.

However, while it is acceptable that some microorganisms have the capacity to directly assimilate starch or high-molecular-weight proteins, because they have enzymatic equipment necessary for their degradation for their growth and for the production of metabolites of interest, for other microorganisms, it is necessary to place them under conditions where the carbon and nitrogen sources are treated so as to be directly assimilable.

These treatments are therefore to be adapted according to the physiology of the microorganisms of interest.

In a first embodiment of the method in accordance with the invention, for microorganisms, for example, lacking amylases, fermentable sugars are advantageously released form the solubles by heating the said solubles to a temperature of at least 60° C., by treating with an α-amylase and a glucoamylase and optionally using an enzyme capable of degrading parietal polysaccharides of plant origin chosen from the group of hemicellulases, pectinases and xylanases.

In a second embodiment of the method in accordance with the invention, for microorganisms incapable of assimilating high-molecular-weight proteins, amino acids and/or peptides which are assimilable are advantageously released from the solubles by treating with proteolytic enzymes chosen, for example, from the group consisting of alkaline proteases and acid proteases.

A treatment at pH 7 and at a temperature of 60° C. for about 6 hours, at a dose of 1% on a dry basis may be advantageously used for the treatment with alkaline proteases.

As for the acid proteases which are suitable for carrying out the proteolysis, they are chosen from the group of pancreatin, trypsin, chymotrypsin, and the like.

A treatment at pH 4.5 and at a temperature of 60° C. for about 6 h, at a dose of 1% on a dry basis may be advantageously used for the treatment with the acid proteases.

This proteolysis step forms peptides which may, in addition, have an activating effect on certain microorganisms.

Finally, in a third embodiment of the method in accordance with the invention, these two treatments of the solubles by liquefaction and saccharification, on the one hand, and by proteolysis, on the other hand, may be carried out for the fermentation by microorganisms incapable of directly assimilating the carbon and nitrogen sources as present in the said solubles.

As will be exemplified below, the content of trace elements, or even of vitamins, of the solubles makes them particularly attractive for a good number of fermentations.

The third step of the method in accordance with the invention therefore consists in recovering the self-sufficient fermentation medium thus obtained and using it directly in fermentation.

It may be advantageously chosen to subject the self-sufficient fermentation medium to an additional microfiltration step in order to remove the insoluble impurities thereform.

This step may be carried out using any means known otherwise to persons skilled in the art, such as microfiltration on membranes whose pore size is adapted to the size of the said insoluble impurities. A 0.14 μm membrane can thus, for example, be used.

These media are particularly suitable for the production of lactic acid, lysine, ethanol, enzymes, for the production of polysaccharides chosen from the group of pullulans and of dextrans and also for the production of populations of microorganisms relating thereto such as, for example, lactic ferments or yeasts.

The applicant company finally also has the merit of proposing a particular solution for using the self-sufficient fermentation medium in accordance with the invention if it is desired to recover the metabolites produced without the need to carry out cumbersome and expensive purification steps.

Indeed, it is commonly accepted, for example, in the case of the use of wheat solubles, that B starch or second starch contains impurities such as pentosans and lipids.

These impurities, some of which escape conventional purification and demineralization treatments, are found in the hydrolyzates of these starches, and thus make the B starch unfit, for example, for the manufacture of food-grade dextrose. That is why it is considered that it is only with difficulty that industrial uses can be found for such “B” starches.

Under these conditions, the applicant company has the merit, not only of having developed a method which makes it possible to treat these wheat solubles so as to produce a self-sufficient fermentation medium, but also to propose a solution to the preparation of metabolites of a quality such that it will not be necessary to apply to said metabolites excessively demanding purification methods.

This solution consists in reducing the content of self-sufficient fermentation medium and to supplement it with a directly assimilable carbon source, so as to supply the chosen microorganism with the quantity of carbon necessary both for its growth and to allow the production of metabolites of interest, without loss of yield or productivity.

The residual part of the self-sufficient fermentation medium should nevertheless adjusted so as to maintain the nitrogen, mineral salt and vitamin supplies essential for the microorganisms, as will be exemplified below for the lactic acid fermentation.

Other characteristics and advantages of the invention will appear on reading the examples which follow. They are however given here by way of illustration and without limitation.

### EXAMPLE 1

Wheat solubles containing 20% of dry matter, obtained from the separation stream of wheat “B” starches are heated at 60° C. for 12 h and treated using an α-amylase TERMAMYL LC from NOVO in an amount of 0.05% on a dry basis.

From the wheat solubles thus treated, three self-sufficient fermentation media may be obtained, the first resulting from the saccharification of the starch of the wheat solubles thus liquefied (product A), the second resulting from the treatment of the wheat solubles liquefied with proteases (product B), the third resulting from the two abovementioned treatments (product C).

For the preparation of product A, the solubles thus liquefied are brought to a DM content of between 15 and 20% and treated for 3 to 5 hours at 60° C. with an amyloglucosidase OPTIDEX L 300 A from GENENCOR in an amount of 0.5% on a dry basis and a hemicellulase SPEZYME CP from GENENCOR in an amount of 0.3% on a dry basis in order to release the fermentable sugars. The insolubles are removed by microfiltration on a 0.14 μm membrane.

The product A, having a dry matter content of 14.6% in accordance with the invention, has the composition presented in the following Table I.

TABLE I

| | Product A |
|---|---|
| Free glucose (% on a dry basis) | 55.4 |
| Fructose (% on a dry basis) | 8.9 |
| Nitrogen (N 6.25) (% on a dry basis) | 6.4 |
| Salts (% on a dry basis) | 4.9 |
| PO₄ (% on a dry basis) | 1.7 |

To prepare product B, the liquefied wheat solubles are also brought to a DM content of between 15 and 20% (the pH is adjusted to a value between 7.5 and 8 with 1N sodium hydroxide), and treated at 60° C. for 4 to 6 hours using ALCALASE Novo in an amount of 0.2 to 1% on a dry basis. The product obtained has a final pH of the order of 6.5 to 7. The insolubles are removed by microfiltration on a 0.14 μm membrane.

Product B having a dry matter content of 14.8% in accordance with the invention has the composition presented in the following Table II.

TABLE II

| | Product B |
|---|---|
| Total glucose (% on a dry basis) | 52.2 |
| Fructose (% on a dry basis) | 7 |
| Nitrogen (N 6.25) (% on a dry basis) | 7 |
| Salts (% on a dry basis) | 5.2 |
| PO₄ (% on a dry basis) | 1.5 |

To prepare product C, the wheat solubles are first of all subjected to saccharification under the same conditions as for the preparation of product A, and then a treatment using ALCALASE under the same conditions which make it possible to obtain product B. The insolubles are also removed by microfiltration on a 0.14 μm membrane.

Product C having a dry matter content of 18.4% in accordance with the invention has the composition presented in the following Table III.

TABLE III

| | Product C |
|---|---|
| Total glucose (% on a dry basis) | 42.4 |
| Fructose (% on a dry basis) | 6.5 |
| Nitrogen (N 6.25) (% on a dry basis) | 10.9 |
| Salts (% on a dry basis) | 5.0 |
| PO₄ (% on a dry basis) | 1.8 |

The aminograms produced on these three wheat-solubles-based self-sufficient fermentation media in accordance with the invention show a remarkable content of acidic amino acids and amino acids with nonpolar radicals, i.e. respectively of the order of 2250 and 1050 mg/kg of DM.

### EXAMPLE 2

From potato solubles, using the method of treatment described in Example 1 for product A, the following self-sufficient fermentation medium D is obtained. The following Table IV presents the profiles of this self-sufficient fermentation medium.

TABLE IV

| | Product D |
|---|---|
| Free glucose (% on a dry basis) | 8 |
| Nitrogen (N 6.25) (% on a dry basis) | 25.3 |
| Salts (% on a dry basis) | 20.2 |
| PO₄ (% on a dry basis) | 2 |

The aminograms produced on this self-sufficient fermentation medium in accordance with the invention show a remarkable content of acidic amino acids and amino acids with nonpolar radicals, i.e. respectively of the order of 2730 and 1100 mg/kg of DM.

In addition, the fermentation media thus obtained are rich in vitamin B7 (content 4 times higher than what yeast extracts conventionally contain) and in vitamin B3.

### EXAMPLE 3

From pea solubles, using the method of treatment described in Example 1 for product A, the following self-sufficient fermentation medium E is obtained.

The following Table V presents the profiles of this self-sufficient fermentation medium.

TABLE V

| | Product E |
|---|---|
| Free glucose (% on a dry basis) | 13 |
| Nitrogen (N 6.25) (% on a dry basis) | 24.2 |
| Salts | 15.6 |
| PO₄ | 1.2 |

The aminograms produced on the self-sufficient fermentation medium in accordance with the invention show a remarkable content of amino acids with basic radicals and amino acids with acidic radicals, i.e. respectively of the order 13 150 and 26 780 mg/kg of DM.

### EXAMPLE 4

The following Table VI presents the yield and productivity for L-lactic acid which are obtained in a fermenter having a useful volume of 15 l with 13 l of wheat solubles treated according to the method in accordance with the invention (products A to C of Example 1).

As a “standard medium” control, a fermentation medium composed of 80 g/l of glucose, 10 g/l of yeast extracts and 0.5 g/l of (NH₄)₂HPO₄ is tested.

The dry matter content of 150 to 180 g/l of the self-sufficient fermentation media in accordance with the invention which are used is chosen so that the said media contain of the order of 80 g/l of “glucose equivalent”.

Depending on the method of treatment of the wheat solubles, these “carbon or nitrogen equivalents” will therefore be directly assimilable or not for the microorganism considered.

A self-sufficient fermentation medium equivalent to product C of Example 1 but not microfiltered (called “crude” product C) is also tested as a “non-microfiltered” control.

1.5 l of medium from a 7 h preculture of a strain of Lactococcus lactis are used to inoculate these fermenters.

The pH, set at 6.5, is regulated with 12N NH₄OH. The temperature is 40° C.

TABLE VI

| | Duration of | | | |
|---|---|---|---|---|
| | fermentation | Biomass | L-Lactic | PO₄ |
| | (h) | (g/l) | (g/l) | (g/l) |
| “Standard medium” control | 20 | 8 | 80 | 0 |
| Product A at 180 g/l | 20 | 2 | 20 | 2.4 |
| Product B at 180 g/l | 20 | 3 | 30 | 2.2 |
| Product C at 150 g/l | 18 | 7 | 80 | 2 |
| Crude product C at 180 g/l | 18 | 8 | 80 | 2.1 |

This table shows that for a microorganism of the genus Lactococcus lactis producing L-lactic acid, a self-sufficient medium based solely on wheat solubles, where the carbon and nitrogen sources are made directly assimilable by a suitable treatment (in this case liquefaction and saccharification of wheat “B” starch and proteolysis using ALCALASE of the protein content) makes it possible to obtain a yield and a productivity which are at least equivalent with what is obtained using a standard production medium which is much more expensive, based on pure glucose and yeast extracts.

The liquefied, saccharified and proteolysed wheat solubles can therefore be advantageously used for lactic fermentation. The test carried out with the non-microfiltered product C also shows that for this particular fermentation, the insoluble impurities do not in any way interfere with the yield or the productivity for L-lactic acid.

Finally, the determination of the biomass was carried out at the end of the fermentation for all the tests undertaken.

It is clearly apparent that the solubles treated according to the method in accordance with the invention, in this case by liquefaction, saccharification and proteolysis, prove as effective for the growth of L. lactis as the reconstituted standard medium. The self-sufficient medium in accordance with the invention is therefore well suited to the production of biomass, in particular here for the production of lactic ferments.

### EXAMPLE 5

The excessive use of wheat solubles in relation to the quality of the metabolite produced, and thereby the possibility of developing a cumbersome purification technology may be deplored.

It is possible to limit the supply of treated wheat solubles in following the method in accordance with the invention, by controlling the fermentation conditions, i.e. by the perfect knowledge of the nutritional requirements of the microorganism(s) in question.

In the case of the production of L-lactic acid with Lactococcus lactis, as presented in Example 4, it is possible to bring the dry matter content of product C to 40 g/l (“glucose equivalent of 20 g/l”) and to compensate for the reduction in carbon source required by the addition of 85 g/l of glucose (which may, for example, be produced from wheat starch hydrolysate).

The following Table VII presents the results obtained.

TABLE VII

| | Duration of | | | |
|---|---|---|---|---|
| | fermentation | Biomass | L-Lactic | PO₄ |
| | (h) | (g/l) | (g/l) | (g/l) |
| “Standard medium” control | 20 | 8 | 80 | 0 |
| Product C at 150 g/l | 18 | 7 | 80 | 2 |
| Product C at 40 g/l + | 23 | 8.1 | 103.5 | <0.05 |
| glucose at 85 g/l | | | | |

The “residual” supply of nitrogen, of carbon source and of trace elements makes it possible to preserve equivalent yields and productivity for an impurity load which has decreased by a factor of 3.75.

### EXAMPLE 6

Fermentation by the yeasts of the S. cerevisiae type is conventionally carried out for the production of ethanol.

The production of yeast biomass is studied using the self-sufficient fermentation medium in accordance with the invention in comparison with a conventional medium consisting of yeast extracts as nitrogen source, and of glucose as carbon source, supplemented with salts.

The production of S. cerevisiae biomass is carried out in a medium prepared from product A of Example 1 in the amount of 80 g/l.

The control medium consists of glucose at 45 g/l, yeast extracts at 5 g/l, (NH₄)₂SO₄ at 10 g/l, of KH₂PO₄ at 5 g/l and MgSO₄ at 2 g/l.

The pH is regulated at 5 with 1N sodium hydroxide, the temperature is set at 30° C. and the culture is carried out in a 2 l reactor, with stirring at 600 rpm and an aeration of 1 vvm.

The following Table VIII presents the result of the growth of yeasts over time for the two fermentation media.

TABLE VIII

| | |
|---|---|
| Product A at 80 g/l | Conventional medium |

| Time | Biomass | Glucose | Biomass | Glucose |
|---|---|---|---|---|
| (h) | (g/l) | (g/l) | (g/l) | (g/l) |
| 0 | 0.6 | 49 | 0.4 | 45 |
| 5 | 2.5 | nd* | 1.2 | 35 |
| 8 | 5.7 | nd* | 4 | 15 |
| 23 | 17.6 | 0 | 10.8 | 0 |

*not determined

This result shows likewise that the self-sufficient fermentation medium in accordance with the invention is particularly well suited to the production of yeast biomass, and by extension, to all productions of metabolites whose synthesis is concomitant with the growth of the said yeasts, as in the case of the production of ethanol.

### EXAMPLE 7

The production of ethanol is studied using the self-sufficient fermentation medium in accordance with the invention in comparison with a conventional medium consisting of yeast extracts as nitrogen source, and of glucose as carbon source, supplemented with salts.

The production of S. cerevisiae biomass is carried out in a medium prepared from product A of Example 1 in the amount of 180 g/l.

The control medium consists of glucose at 10 g/l, yeast extracts at 5 g/l, (NH₄)₂SO₄ at 10 g/l, of KH₂PO₄ at 5 g/l and MgSO₄ at 2 g/l.

The pH is regulated at 5 with normal sodium hydroxide, the temperature is set at 30° C. and the culture is carried out in a 15 l reactor, with stirring at 200 rpm.

The following Table IX presents the result of the growth of yeasts over time for the two fermentation media.

TABLE IX

| | |
|---|---|
| Product A at 80 g/l | Conventional medium |

| Time | Glucose | Ethanol | Glucose | Ethanol |
|---|---|---|---|---|
| (h) | (g/l) | (g/l) | (g/l) | (g/l) |
| 0 | 95 | 0 | 100 | 0 |
| 8 | 75 | 10 | 81 | 8 |
| 24 | 45 | 23 | 53 | 20 |
| 48 | 0 | 42 | 0 | 43 |

The self-sufficient fermentation medium in accordance with the invention is therefore particularly well suited to the production of ethanol.

1. Method for preparing a self-sufficient fermentation medium allowing the production of metabolites from a renewable raw material, consisting in:
selecting the renewable raw material from the group consisting of wheat, pea and potato solubles, preferably wheat solubles,
treating the said renewable raw material so as to release therefrom the carbon and nitrogen sources directly assimilable by microorganisms,
recovering the self-sufficient fermentation medium thus obtained.

2. Method according to claim 1, wherein the self-sufficient fermentation medium is subjected to a microfiltration step so as to remove the insoluble impurities therefrom.

3. Method according to claim 1, wherein the renewable raw material is treated with enzymes for liquefying and saccharifying starch so as to release therefrom the content of directly assimilable carbon source.

4. Method according to claim 1, wherein the renewable raw material is treated with proteolytic enzymes selected from the group consisting of alkaline proteases so as to release therefrom the content of directly assimilable nitrogen source.

5. Method for preparing a fermentation medium allowing the production of easily purifiable metabolites from a self-sufficient fermentation medium prepared according to the method of claim 1, wherein it is supplemented with a directly assimilable carbon source.

6. Fermentation medium obtained by the method according to claim 1.

7. Method for producing lactic acid, comprising a fermentation step using the fermentation medium according to claim 6.

8. Method for producing lysine, comprising a fermentation step using the fermentation medium according to claim 6.

9. Method for producing polysaccharides selected from the group of pullulans and dextrans, and more preferably pullulans, comprising a fermentation step using the fermentation medium according to claim 6.

10. Method for producing populations of microorganisms, comprising a fermentation step using the fermentation medium according to claim 6.

11. Method for producing enzymes, comprising a fermentation step using the fermentation medium according to claim 6.

12. Method for producing ethanol, comprising a fermentation step using the fermentation medium according to claim 6.
